(19) United States
(12) Patent Application Publication
(10) Pub. No.: US 2013/0181947 A1
(43) Pub. Date: Jul. 18, 2013

(54) TOUCH SCREEN PANEL

(71) Applicant: Samsung Electro-Mechaics Co., Ltd., Gyeonggi-do (KR)

(72) Inventors: Yong IL Kwon, Gyeonggi-do (KR); Tah Joon Park, Gyeonggi-do (KR); Sang Ho Lee, Gyeonggi-do (KR); Kyung Hee Hong, Seoul (KR)

(73) Assignee: SAMSUNG ELECTRO-MECHANICS CO., LTD., Gyeonggi-do (KR)

(21) Appl. No.: 13/717,517

(22) Filed: Dec. 17, 2012

(30) Foreign Application Priority Data
Dec. 21, 2011 (KR) 10-2011-0139242

(51) Int. Cl. G06F 3/044

(52) U.S. Cl. CPC G06F 3/044
USPC 345/175

(57) ABSTRACT

Disclosed herein is a touch screen panel. The touch screen panel includes: a driving unit generating a driving signal; a signal sensing unit that is activated by the driving signal input from the driving unit; and a signal detection unit that generates a combination signal by using a sensing signal generated by capacitance sensed by the signal sensing unit, and counts a period of the sensing signal by using the combination signal to calculate a counting value and calculates a delay time of a remaining period after the counting, and combines the calculated values to determine a cell in which the capacitance is generated.

### CROSS REFERENCE(S) TO RELATED APPLICATIONS

This application claims the benefit under 35 U.S.C. Section 119 of Korean Patent Application Serial No. 10-2011-0139242, entitled “Touch Screen Panel” filed on Dec. 21, 2011, which is hereby incorporated by reference in its entirety into this application.

### BACKGROUND OF THE INVENTION

1. Technical Field

The present invention relates to a touch screen panel, and more particularly, to a capacitive touch screen panel which does not use an analog-digital converter (ADC).

2. Description of the Related Art

Currently, various electric and electronic devices including portable electronic devices widely range in use. The types of devices used include mobile communication terminals such as mobile phones, personal digital assistants (PDA), and digital multimedia broadcasting (DMB) phones, or multi-media devices such as MP3 players or game players.

In particular, portable electronic devices are combined with data-exclusive networks or complex sound and data networks such as global system for mobile communication (GSM) or code division multiple access (CDMA), etc. and thus emphasis on portability of devices is increasing.

A touch screen panel is particularly useful in the above portable devices.

In general, a touch screen panel is a device to which data is input by contacting finger or a pen on a screen instead of using an input device such as a keypad or a mouse. A touch screen panel may be formed of a touch screen through which electrical changes may be sensed by a contact and a controller chip (integrated chip, IC) that converts a signal sensed by the touch panel into digital data and transmits the data to a device such as a computer or a mobile phone.

Touch perception methods include a resistive method, a capacitive method, an infrared ray method, an ultrasonic method, and while each method has advantages and disadvantages, a ratio of capacitive touch screen panels with which multiple touches may be implemented is currently increasing.

Methods of operating capacitive touch screen panels may be divided into a self cap method and a mutual cap method.

In the self cap method, a signal generating unit generating a signal to be detected and a signal detection unit detecting a signal are included in the same block, and in the mutual cap method, a signal generating unit and a signal detection unit are included in different blocks.

In the self cap method, when multiple touches are made, a shadow area is formed. Consequently, the mutual cap method is recently more commonly used.

In a capacitive touch screen panel in which the mutual cap method is used, a touch position is calculated based on an amplitude of a signal that is amplified on a charge amplifier, and here, an analog-digital converter (ADC) having a very high resolution is required.

However, if resolution of an ADC is increased, the total surface area of the ADC is increased.

Thus, according to the conventional art, in order to reduce an increase in the surface area of the ADC, a single ADC is used by using a Mux unit to thereby reduce the total surface area of a touch screen panel.

However, if a single ADC is used, values are sequentially processed, and thus the processing speed is low.

Currently, a Mux is not used but a plurality of ADCs are applied to respectively correspond to a plurality of integrators.

However, in this case, since a large number of ADCs having a high bit number are used in parallel according to the number of channels, the total surface area of the touch screen panel is increased.

### SUMMARY OF THE INVENTION

An object of the present invention is to provide a touch screen panel capable of reducing a total surface area of the touch screen panel and increasing accuracy thereof.

According to an exemplary embodiment of the present invention, there is provided a touch screen panel, including: a driving unit generating a driving signal; a signal sensing unit that is activated by the driving signal input from the driving unit; and a signal detection unit that generates a combination signal by using a sensing signal generated by capacitance sensed by the signal sensing unit, and counts a period of the sensing signal by using the combination signal to calculate a counting value and calculates a delay time of a remaining period after the counting, and combines the calculated values to determine a cell in which the capacitance is generated.

According to another exemplary embodiment of the present invention, there is provided a touch screen panel including: a driving unit generating a driving signal; a signal sensing unit that is activated by the driving signal input from the driving unit; a charge integrating unit that integrates charges according to a change in capacitance that is sensed by the signal sensing unit to generate the sensing signal; a converting unit that counts a period of the sensing signal generated in the charge integrating unit to calculate a counting value and calculates a delay time of a remaining period after the counting; and a control unit that combines the values calculated by using the converting unit to determine a cell at which the capacitance is generated.

According to another exemplary embodiment of the present invention, there is provided a method of detecting a touch cell of a touch screen panel, the method including: activating a touch screen panel by generating driving signals; generating a sensing signal by integrating charges according to a change of a sensing cell by using a charge integrating unit in the signal detection unit; generating a comparison signal by receiving the sensing signal from the comparing unit and comparing the sensing signal with a previously set reference voltage; generating a combination signal by receiving the comparison signal from the combination unit and combining the comparison signal with a switch enable signal, and supplying the generated combination signal to a counter unit and a time delay control (TDC); counting a pulse signal with respect to the combination signal by using the counter unit as a reference clock, and calculating the counted value; calculating a value regarding the remaining delay time of the counting by using the TDC as a digital value; and combining, by the control unit, a calculation value of the counter unit and a calculation value of the TDC to detect the sensing cell.

### BRIEF DESCRIPTION OF THE DRAWINGS

FIG. 1 is a block diagram illustrating the entire touch screen panel according to an embodiment of the present invention;

FIG. 2 is a detailed block diagram illustrating a touch screen panel according to an embodiment of the present invention;

FIG. 3 is a detailed circuit diagram illustrating a time delay control (TDC) of FIG. 1;

FIGS. 4A, 4B, 4C, 4D and 4E are graphs showing outputs of components inside a signal detection unit according to an embodiment of the present invention;

FIG. 5 is a graph showing input and output (signals?) of a TDC; and

FIG. 6 is a flowchart illustrating a touch sensing method of a touch screen panel according to an embodiment of the present invention.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

Hereinafter, a touch screen panel according to exemplary embodiments of the present invention will be described in detail with reference to the accompanying drawings.

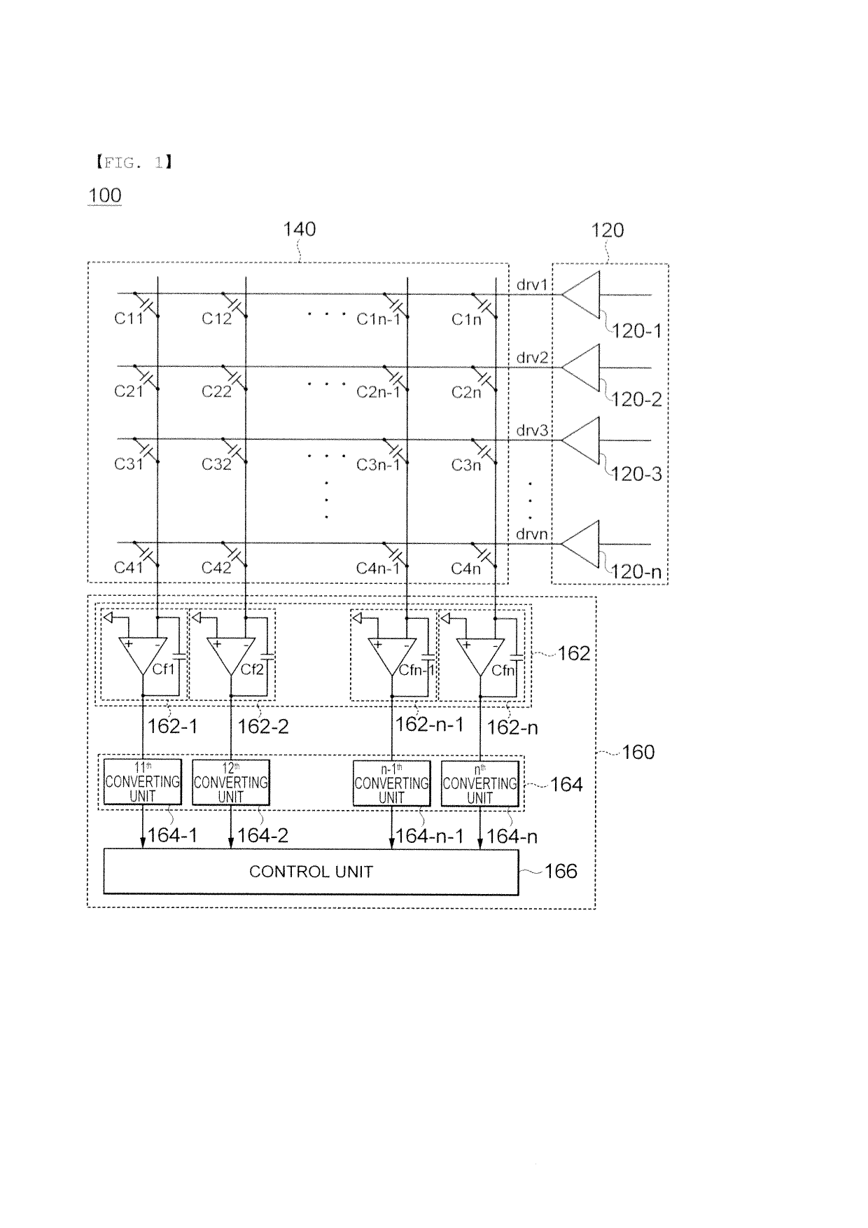

FIG. 1 is a block diagram illustrating the entire touch screen panel 100 according to an embodiment of the present invention.

As illustrated in FIG. 1, the touch screen panel 100 includes a driving unit 120, a signal sensing unit 140, and a signal detection unit 160.

The driving unit 120 may include a plurality of drivers 120-1 through 120-n, and driving signals drv1 through drvn generated from the plurality of drivers 120-1 through 120-n may be supplied to the signal sensing unit 140 via driving lines.

The signal sensing unit 140 may be formed of a plurality of sensing cells C11 through C4n that are arranged between a plurality of driving lines (X-axis lines in FIG. 1) and a plurality of sensing lines (Y-axis lines in FIG. 1) that are arranged in a direction to cross the plurality of driving lines. The plurality of sensing cells C11 through C4n may each be a single capacitor.

When a driving signal is applied from the driving unit 120, interactive capacitance generated in the signal sensing unit 140 is supplied to the signal detection unit 160 so that the signal detection unit 160 may generate a sensing signal Ch_out.

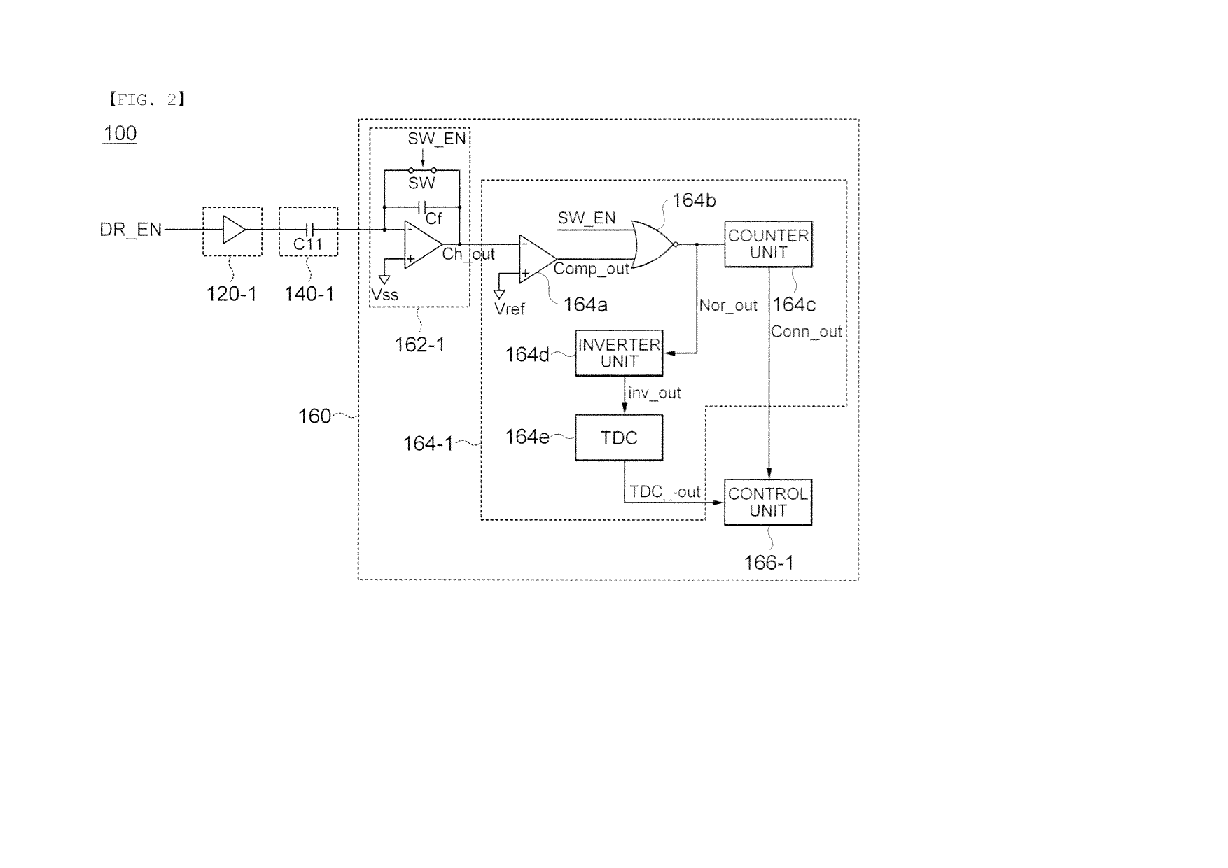

In detail, it will be assumed that a user touches a first sensing cell C11 (140-1 in FIG. 2) of the signal sensing unit 140, and this will be described as an example in detail with reference to FIG. 2.

First, when the user touches the first sensing cell C11 (140-1 of FIG. 2), interactive capacitance is generated in first sensing cell C11 (140-1 of FIG. 2). The generated interactive capacitance may be supplied to the signal detection unit 160 via a sensing line that is connected to an output end of the first sensing cell C11 (140-1 of FIG. 2) when a driving signal is applied from the first driving unit 120-1 via a driving line connected to the first sensing cell C11 (140-1 of FIG. 2). Then, the signal detection unit 160 may generate a sensing signal based on the interactive capacitance.

The signal detection unit 160 may detect the sensing signal Ch_out generated by capacitance sensed by the signal sensing unit 140, and may determine a position where the capacitance is generated based on the detected sensing signal Ch_out.

In detail, the signal detection unit 160 may integrate charges according to a change of a corresponding sensing cell to generate a sensing signal Ch_out, and compare the generated sensing signal Ch_out and a previously set reference voltage Vref to generate a comparison signal Comp_out.

In addition, the signal detection unit 160 may combine the generated comparison signal Comp_out and a switch enable signal SW_EN to generate a combination signal Nor_out which is a clock signal for counting.

In addition, the signal detection unit 160 may count a period of the sensing signal Ch_out by using the combination signal Nor_out to calculate a counting value, and calculate a delay time of the remaining period after the counting and provide the delay time to a control unit 166.

The signal detection unit 160 may include a charge integrating unit 162, a converting unit 164, and the control unit 166.

The charge integrating unit 162 may include a plurality of charge integrating units 162-1 through 162-n respectively corresponding to a plurality of sensing lines. The plurality of the charge integrating units 162-1 through 162-n have the same structures, and here, for convenience of description, only the first charge integrating unit 162-1 will be described among the plurality of charge integrating units 162-1 through 162-n.

As illustrated in FIG. 2, the first charge integrating unit 162-1 may be formed of an integration circuit that includes a comparator and an integration capacitor Cf. One end of the integration capacitor Cf may be connected to a non-inverse end (−) of the comparator, and the other end of the integration capacitor Cf may be connected to an output end of the comparator.

In addition, the first charge integrating unit 162-1 may further include a switch SW that is connected between both ends of the integration capacitor Cf.

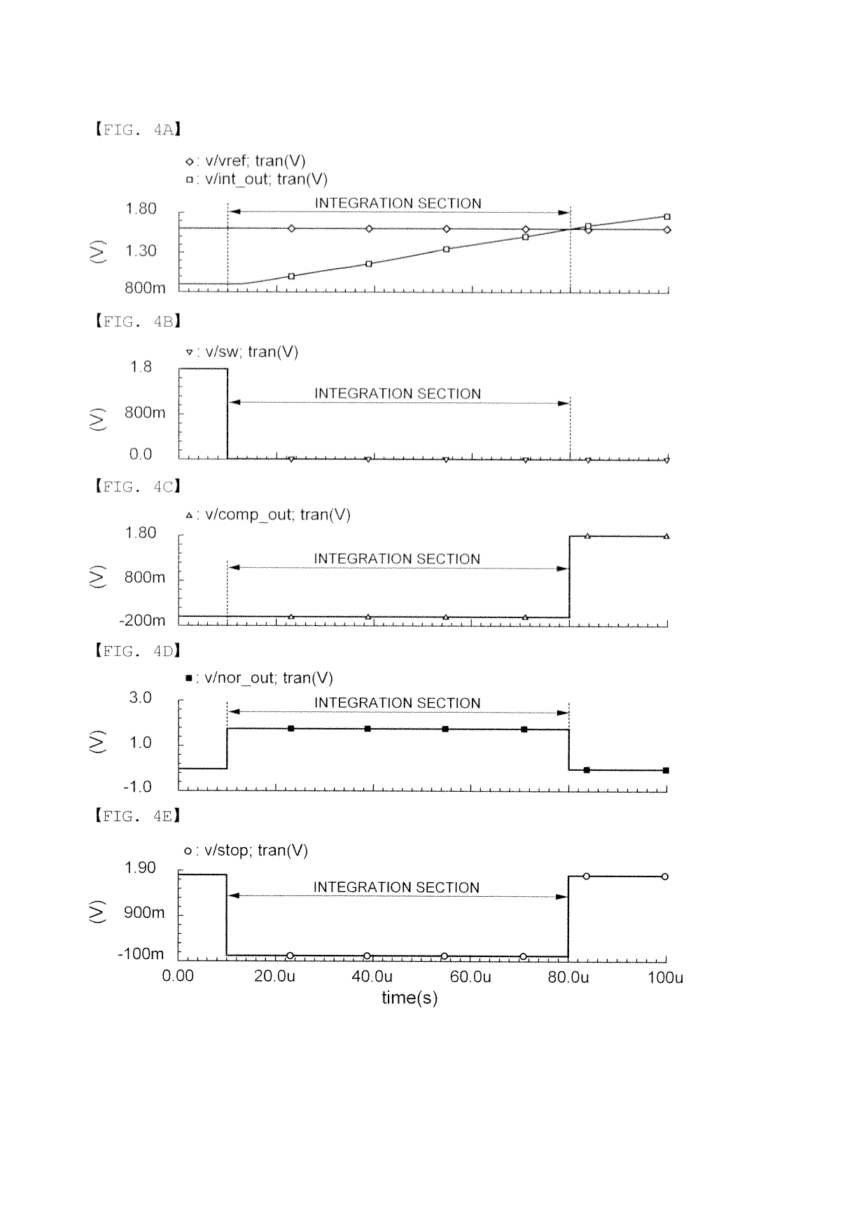

The switch SW according to the current embodiment of the present invention is used to discharge charges that are charged in the integration capacitor Cf in response to the switch enable signal SW_EN, and as illustrated in FIG. 4B, the switch enable signal SW_EN notifies a starting point of an integration section so as to guide a more accurate measurement of the sensing signal Ch_out.

In detail, the switch SW is turned on when a high-level switch enable signal SW_EN is input so that charges charged in the integration capacitor Cf may be discharged. On the other hand, the switch SW is turned off when a low-level switch enable signal SW_EN is input so that charges may be charged in the integration capacitor Cf. Then, as illustrated in FIG. 4A, the charge integrating unit 162 may determine the sensing signal Ch_out according to a change of an input voltage.

The converting unit 164 may count a period of the sensing signal Ch_out generated in the charge integrating unit 162 to calculate counting values and a delay time of the remaining period that is left after the counting, and may provide each of the calculated values to a control unit 166-1.

The converting unit 164 may be formed of a plurality of converting units 164-1 through 164-n so as to respectively correspond to a plurality of the charge integrating units 162. The plurality of converting units 164-1 through 164-n according to the current embodiment of the present invention have the same structures, and thus, for convenience of description, here, only the first converting unit 164-1 will be described among the plurality of converting units 164-1 through 164-n.

The first converting unit 164-1 may include, as illustrated in FIG. 2, a comparator 164a, a combining unit 164b, a counter unit 164c, and a time delay control (TDC) 164e.

The comparator 164a compares a sensing signal Ch_out that is output from the charge integrating unit 162 with a previously set reference voltage Vref to generate a comparison signal Comp_out.

The combining unit 164b combines the comparison signal Comp_out output from the comparing unit 164a and a switch enable signal SW_EN to generate a combination signal Nor_out, and may supply the generated combination signal Nor_out to the counter unit 164c and the TDC 164e. The generated combination signal Nor_out may be supplied to the counter unit 164c and be used as a reference clock signal to count the number of periods.

For example, the combination unit 164b may be formed of a Nor gate. Accordingly, when either the comparison signal Comp_out or the switch enable signal SW_EN is input in a high-level state, the combination unit 164b may generate a low-level combination signal Nor_out as illustrated in FIG. 4C. On the other hand, when both the comparison signal Comp_out and the switch enable signal SW_EN are input in a low-level state, the combination unit 164b may generate a high-level combination signal Nor_out as illustrated in FIG. 4C.

Accordingly, the combination unit 164b according to the current embodiment of the present invention may generate a combination signal Nor_out which has a high-level only in an integration section as illustrated in FIG. 4C.

The counter unit 164c may count the number of periods by using the combination signal Nor_out output from the combination unit 164b as a reference clock.

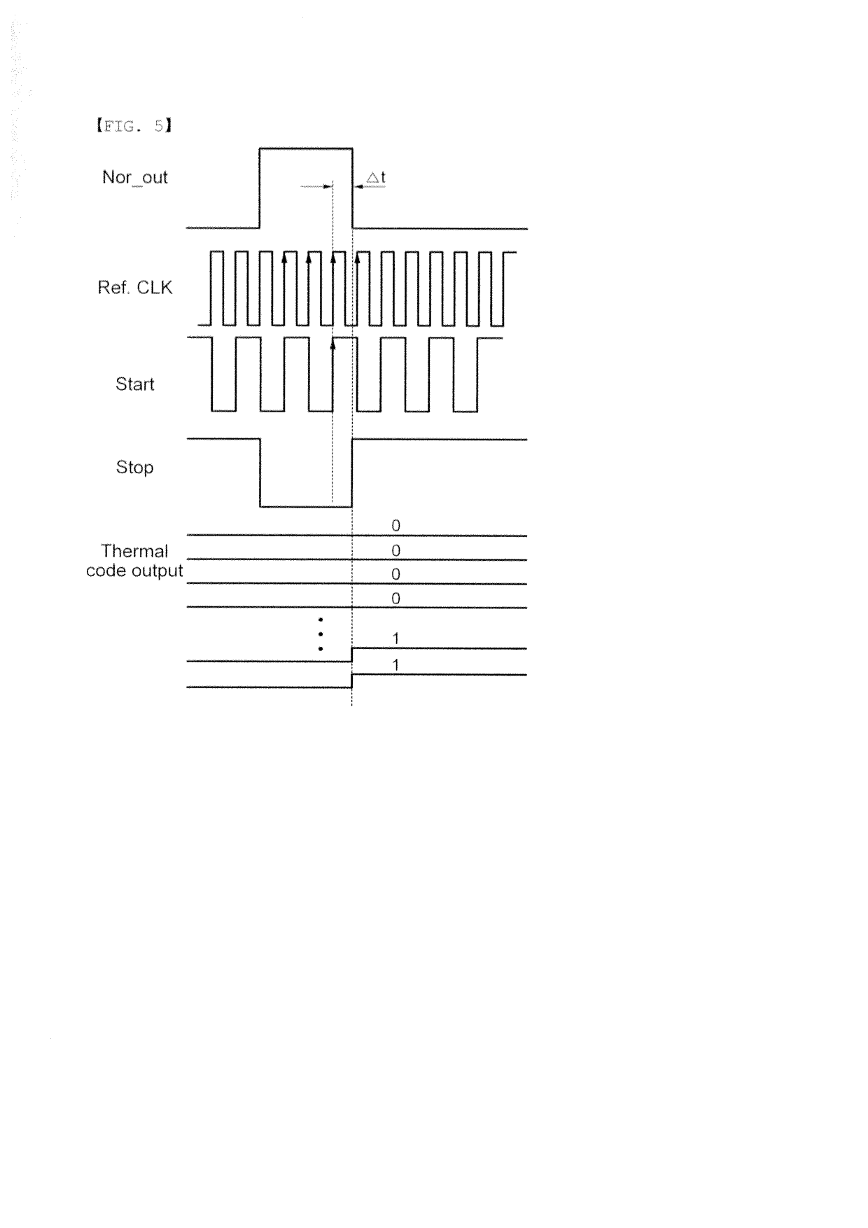

In detail, as illustrated in FIG. 5, the counter unit 164c may count the number of periods only during a high-level section of the combination signal Nor_out in a rising section of a reference clock Ref CLK, and may not count during a low-level section of the combination signal Nor_out.

The TDC 164e may receive the combination signal Nor_out, and may convert the input combination signal Nor_out to a digital value. The TDC 164e may conduct counting by using the counter unit 164c, and may calculate the remaining period as a digital value. Here, the remaining period may be a residual section Δt of FIG. 5.

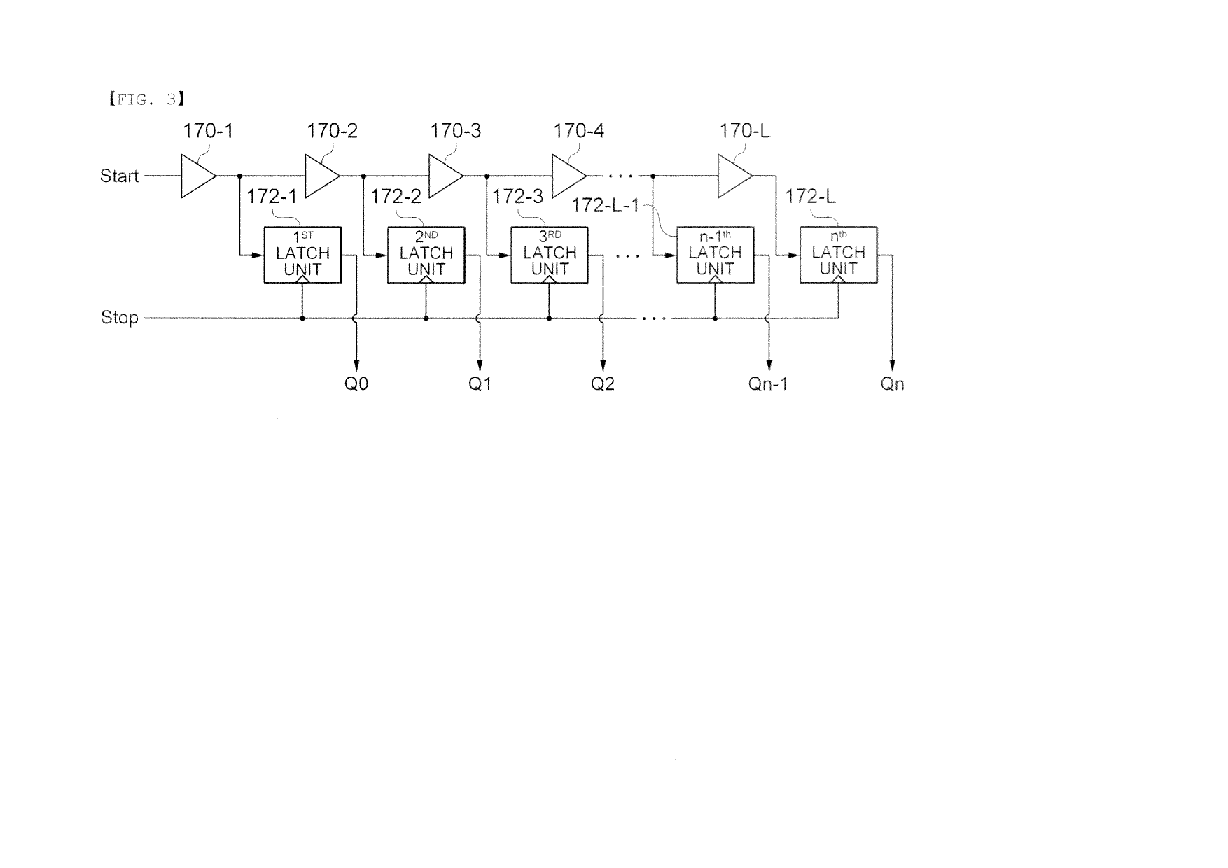

As illustrated in FIG. 3, the TDC 164e may include input signal lines, a plurality of inverters 170-1 through 170-L for signal delay, and a plurality of latch units 172-1 through 172-L that are formed of flip-flops corresponding to the plurality of inverters 170-1 through 170-L. Two input signals, that is, digital-controlled start signal Start and stop signal Stop are input to the TDC 164e. According to the present invention, a start signal Start may be a signal that is input from the reference clock CLK, and the reference clock CLK may be a clock that is used in a touch screen panel as a reference. The start signal Start is delayed by using the plurality of inverters 170-1 through 170-L and are input to each of the plurality of latch units 172-1 through 172-L. In addition, according to the current embodiment, the stop signal Stop may be an output signal of the inverter unit 164d.

The plurality of latch units 172-1 through 172-L may compare risings edges of the start signal Start and rising edges of the stop signal Stop that are delayed and output from each of the inverters 170-1 through 170-L, and may output a comparison result thereof in a digital code as illustrated in FIG. 5, and check a difference between corresponding input signals by using the output digital code.

That is, a start signal Start for measuring a delay may be applied to a start path (not shown) of the TDC 164e, and a stop signal Stop for notifying a point where the delay is ended may be applied to a reset path (not shown) of the TDC 164e. Then, the plurality of latch units 172-1 through 172-L may store values of a time point where the stop signal Stop becomes a high-level, and output the same as a thermal code as illustrated in FIG. 5. Here, values of the output thermal code are converted to digital values.

In addition, the converting unit 164 according to the current embodiment of the present invention may further include an inverter unit 164d which enables storage of data when levels of the latch units 172-1 through 172-L in the TDC 164e are transitioned.

However, according to an embodiment of the present invention, the inverter unit 164d is not an essential element of the converting unit 164, and if it is designed such that data is stored when levels of the latch units 172-1 through 172-L in the TDC 164e are transitioned, the inverter unit 164d may be omitted.

A control unit 165 may add signals supplied by the converting unit 164 to calculate a change of a corresponding sensing cell to calculate a touch position.

As described above, in the touch screen panel 100 according to the current embodiment of the present invention, instead of using an ADC according to the conventional art, the converting unit 164 including the TDC 164e and the counter unit 164c is applied to reduce the conventional ADC specifications to the level of those of a comparator, thereby reducing the total size of the touch screen panel 100 and increasing accuracy thereof.

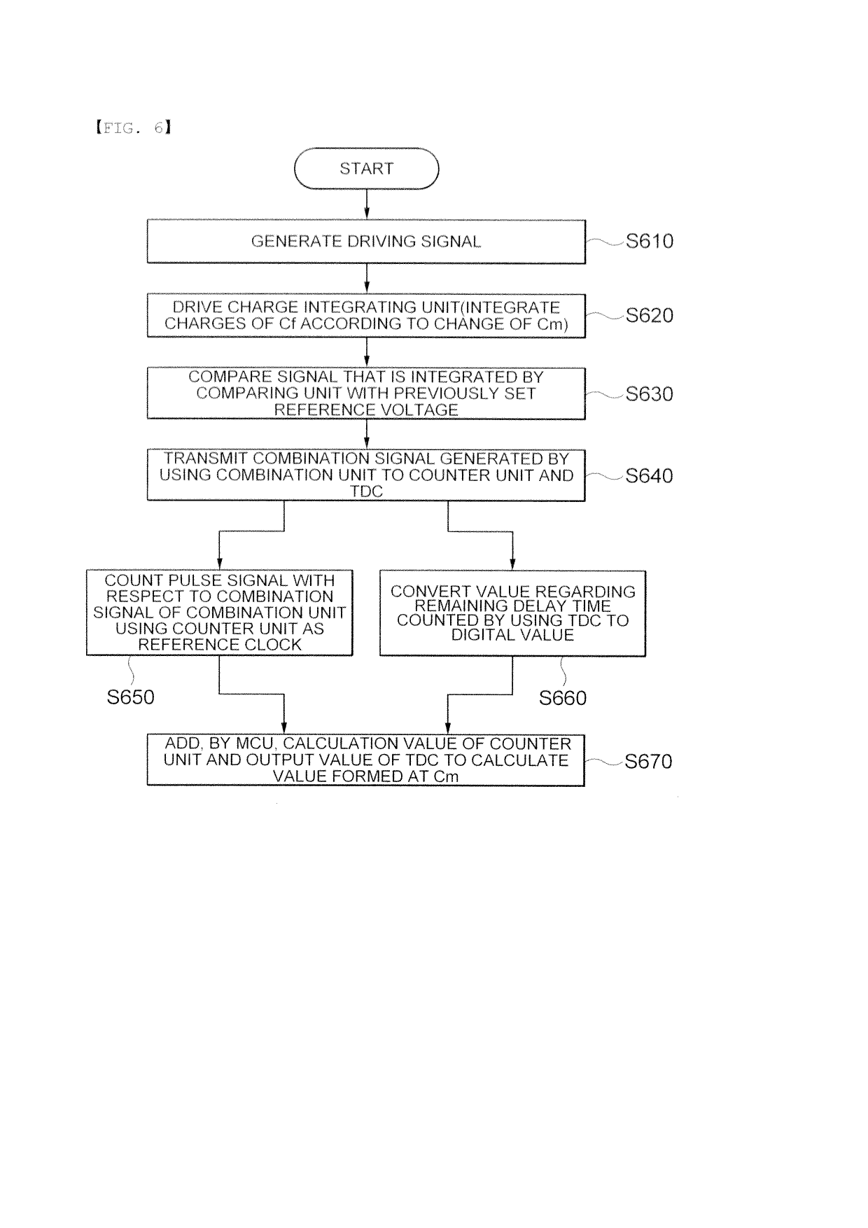

FIG. 6 is a flowchart illustrating a method of calculating a change sensed by a touch screen panel according to an embodiment of the present invention.

First, in S610, a touch screen panel may drive the driving unit 120 to activate driving signals drv1 through drvn to determine whether there is a touch by a user.

In detail, when a user touches one of a plurality of sensing cells C11 through C4n, interactive capacitance is generated in a sensing cell. When a driving signal is applied via a driving line connected to the corresponding sensing cell, the generated interactive capacitance may be supplied to the signal detection unit 160 via a sensing line connected to an output end of the corresponding sensing cell. Then, the signal detection unit 160 may generate a sensing signal Ch_out based on the interactive capacitance.

When a driving signal is generated, the charge integrating unit 162 in the signal detection unit 160 may integrate charges according to the interactive capacitance from the signal sensing unit 140, that is, according to a change of a corresponding sensing cell Cm to generate a sensing signal Ch_out in S620.

Here, in response to an operation of the switch SW, the charge integrating unit 162 may discharge charges that are charged in the integration capacitor Cf.

Then, the generated sensing signal Ch_out is output to the comparator 164a in the signal detection unit 160, and the comparator 164a compares the sensing signal Ch_out and the set reference voltage Vref to generate a comparison signal Comp_out in S630.

The generated comparison signal Comp_out is supplied to the combining unit 164b, and the combining unit 164b may combine a comparison signal Comp_out and a switch enable signal SW_EN to generate a combination signal Nor_out in S640.

The generated combination signal Nor_out may be supplied to the counter unit 164c and be used as a reference clock signal to count the number of periods.

Then, the combination signal Nor_out generated in the combination unit 164b is supplied to the counter unit 164c and the TDC 164e in S640.

First, the counter unit 164c counts a pulse signal with respect to the combination signal Nor_out of the combination unit 164b as a reference clock, and may provide a counted calculated value to the control unit 166-1 in S650. In detail, the counter unit 164c may count a pulse signal during a high-level section of the combination signal Nor_out in a rising section of the reference clock Ref CLK, and may not count a pulse signal during a low-level section of the combination signal Nor_out.

In addition, the TDC 164e may convert a value regarding a remaining delay time of the counting to a digital value, and may supply the calculation value obtained by conversion to the control unit 166 in S660. In detail, the TDC 164e may calculate the period remaining after the counting of the counter unit 164c as a digital value. Here, the remaining period may be the remaining section Δt in FIG. 5.

The plurality of latch units 172-1 through 172-L in the TDC 164e may compare risings edges of the start signal Start and rising edges of the stop signal Stop that are delayed and output from each of the inverters 170-1 through 170-L, and may output a comparison result thereof in a digital code, and check a difference between corresponding input signals by using the output digital code.

That is, a start signal Start for measuring a delay may be applied to a start path (not shown) of the TDC 164e, and a stop signal Stop for notifying a point where the delay is ended may be applied to a reset path (not shown) of the TDC 164e. Then, the plurality of latch units 172-1 through 172-L may store values of a time point where the stop signal Stop becomes a high-level, and output the same as a thermal code as illustrated in FIG. 5.

The control unit 166 may add a calculation value of the counter unit 164c and a calculation value of the TDC 164e to calculate a capacitance conversion value formed at a corresponding sensing cell Cm to detect a corresponding touched cell.

As described above, in the touch screen panel 100 according to the current embodiment of the present invention, instead of using an ADC according to the conventional art, the converting unit 164 including the TDC 164e and the counter unit 164c is applied to reduce the conventional ADC specifications to the level of those of a comparator, thereby reducing the total size of the touch screen panel 100 and increasing accuracy thereof.

According to the embodiments of the present invention, instead of using a conventional ADC, a converting unit including a TDC and a counter unit is applied so as to reduce the specifications of a conventional ADC to the level of those of a comparator, thereby reducing the total size of the touch screen panel and increasing accuracy of the touch screen panel.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A touch screen panel, comprising:
a driving unit generating a driving signal;
a signal sensing unit that is activated by the driving signal input from the driving unit; and
a signal detection unit that generates a combination signal by using a sensing signal generated by capacitance sensed by the signal sensing unit, and counts a period of the sensing signal by using the combination signal to calculate a counting value and calculates a delay time of a remaining period after the counting, and combines the calculated values to determine a cell in which the capacitance is generated.

2. The touch screen panel according to claim 1, wherein the signal detection unit includes:
a charge integrating unit that integrates charges according to a change in the capacitance that is sensed by the signal sensing unit to generate the sensing signal;
a comparing unit that compares the sensing signal output from the charge integrating unit with a previously set reference voltage to generate a comparison signal;
a combination unit that combines the comparison signal output from the comparing unit and a switch enable signal to generate the combination signal for counting a period of the sensing signal,
a counter unit that counts a period of the sensing signal by using the combination signal output from the combination unit to calculate a counting value;
a time delay control (TDC) that calculates a delay time of the remaining period after the counting; and
a control unit that adds a calculation value of the counter unit and a calculation value of the TDC to calculate a change of the corresponding cell to calculate a touch position.

3. The touch screen panel according to claim 2, wherein the charge integrating unit includes:
a comparator;
an integration capacitor whose one end is connected to a non-inverse end of the comparator, and the other end is connected to an output end of the comparator; and
a switch that is connected to both ends of the integration capacitor.

4. The touch screen panel according to claim 3, wherein the switch discharges charges charged in the integration capacitor in response to the switch enable signal.

5. The touch screen panel according to claim 4, wherein the switch is turned on when the switch enable signal having a first level is input so that charges charged in the integration capacitor are discharged.

6. The touch screen panel according to claim 4, wherein the switch is turned off when the switch enable signal having a second level is input so that charges are charged in the integration capacitor.

7. The touch screen panel according to claim 2, wherein the TDC includes:
input signal lines;
a plurality of inverters for signal delay; and
a plurality of latch units that are formed to correspond to the plurality of inverters.

8. The touch screen panel according to claim 7, wherein the input signal lines include a start signal which is a signal input from a reference clock and a stop signal that is generated as a combination signal output from she combination unit is inversed.

9. The touch screen panel according to claim 2, wherein the signal detection unit further includes an inverter unit that generates a signal for notifying a time to store data when levels of the latch units in the TDC are transitioned.

10. A touch screen panel comprising:
a driving unit generating a driving signal;
a signal sensing unit that is activated by the driving signal input from the driving unit;
a charge integrating unit that integrates charges according to a change in capacitance that is sensed by the signal sensing unit to generate the sensing signal;
a converting unit that counts a period of the sensing signal generated in the charge integrating unit to calculate a counting value and calculates a delay time of a remaining period after the counting; and
a control unit that combines the values calculated by using the converting unit to determine a cell at which the capacitance is generated.

11. The touch screen panel according to claim 10, wherein the signal detection unit includes:
a comparing unit that compares the sensing signal output from the charge integrating unit with a previously set reference voltage to generate a comparison signal;
a combination unit that combines the comparison signal output from the comparing unit and a switch enable signal to generate the combination signal for counting a period of the sensing signal;
a counter unit that counts a period of the sensing signal by using the combination signal output from the combination unit to calculate a counting value; and
a time delay control (TDC) that calculates a delay time of the remaining period after the counting.

12. The touch screen panel according to claim 10, wherein the charge integrating unit includes:
a comparator;
an integration capacitor whose one end is connected to a non-inverse end of the comparator, and the other end is connected to an output end of the comparator; and
a switch that is connected to both ends of the integration capacitor.

13. The touch screen panel according to claim 12, wherein the switch discharges charges charged in the integration capacitor in response to the switch enable signal.

14. The touch screen panel according to 13, wherein the switch is turned on when the switch enable signal having a first level is input so that charges charged in the integration capacitor are discharged.

15. The touch screen panel according to claim 13, wherein the switch is turned off when the switch enable signal having a second level is input so that charges are charged in the integration capacitor.

16. The touch screen panel according to claim 11, wherein the TDC includes:
input signal lines;
a plurality of inverters for signal delay; and
a plurality of latch units that are formed to correspond to the plurality of inverters.

17. The touch screen panel according to claim 16, wherein the input signal lines include a start signal which is a signal that is input from a reference clock and a stop signal that is generated as a combination signal output from the combination unit is inversed.

18. The touch screen panel according to claim 11, wherein the converting unit further includes an inverter unit that generates a signal for notifying a time to store data when levels of the latch units in the TDC are transitioned.

19. A method of detecting a touch cell of a touch screen panel, the method comprising:
activating a touch screen panel by generating driving signals;
generating a sensing signal by integrating charges according to a change of a sensing cell by using a charge integrating unit in the signal detection unit;
generating a comparison signal by receiving the sensing signal from the comparing unit and comparing the sensing signal with a previously set reference voltage;
generating a combination signal by receiving the comparison signal from the combination unit and combining the comparison signal with a switch enable signal, and supplying the generated combination signal to a counter unit and a time delay control (TDC);
counting a pulse signal with respect to the combination signal by using the counter unit as a reference clock, and calculating the counted value;
calculating a value regarding the remaining delay time of the counting by using the TDC as a digital value; and
combining, by the control unit, a calculation value of the counter unit and a calculation value of the TDC to detect the sensing cell.
